(19) United States
(12) Patent Application Publication
(10) Pub. No.: US 2026/0119450 A1
(43) Pub. Date: Apr. 30, 2026

(54) COMPUTER SYSTEM AND FILE STORAGE

(71) Applicant: Hitachi Vantara, Ltd., Yokohama-shi (JP)

(72) Inventors: Yuto KAMO, Tokyo (JP); Mitsuo HAYASAKA, Tokyo (JP)

(21) Appl. No.: 19/329,761

(22) Filed: Sep. 16, 2025

(30) Foreign Application Priority Data
Oct. 24, 2024 (JP) 2024-187550

(51) Int. Cl. G06F 16/14; G06F 16/16

(52) U.S. Cl. CPC G06F 16/152; G06F 16/156; G06F 16/164

(57) ABSTRACT

In a computer system including a search server and a plurality of file storages, the search server accepts a search request, transmits a file storage search request corresponding to the search request to the file storage, receives a search result corresponding to the file storage search request from the file storage, and returns the search result to a request source, and the file storage stores a metadata file that stores metadata regarding a file in a snapshot of a file system managed by the file storage, receives the file storage search request from the search server, searches for a file from the metadata file based on the file storage search request, and returns a search result obtained by the searching to the search server.

### CROSS-REFERENCE TO RELATED APPLICATION

The present application claims priority from Japanese application JP2024-187550, filed on Oct. 24, 2024, the content of which is hereby incorporated by reference into this application.

### BACKGROUND OF THE INVENTION

### 1. Field of the Invention

The present invention relates to a data search technique.

### 2. Description of the Related Art

In recent years, utilization of generative artificial intelligence (AI) has attracted attention. In the generative AI, additional learning is performed in the file/database. The learning data may exist in a plurality of sites, and there is a demand for a technology of finding learning data distributed in a plurality of sites.

US 2021/0103555 B discloses a technique that enables global data search by aggregating metadata of files in snapshots in a plurality of sites or a plurality of file storages into one database.

### SUMMARY OF THE INVENTION

In the data search using the technology described in US 2021/0103555 B, it is necessary to aggregate metadata in one DB, and thus there is a problem that a search time increases when the number of file storages or the number of files increases. In addition, since only the metadata of the snapshot is transferred, there is a problem that the created and updated file cannot be searched in the file system after the snapshot is obtained.

The present invention has been made in view of the above circumstances, and an object thereof is to provide a technique capable of easily and appropriately searching for a file from a plurality of file storages.

In order to achieve the above object, a computer system according to one aspect is a computer system including a search server and a plurality of file storages that manage a file system, in which the search server is configured to execute accepting a search request for a file to be searched, transmitting a file storage search request corresponding to the search request to the file storage, receiving a search result corresponding to the file storage search request from the file storage, and returning the search result to a request source of the search request, and the file storage is configured to execute storing a first metadata file that stores metadata regarding a file in a snapshot of a file system managed by the file storage, receiving the file storage search request from the search server, searching for a file from the first metadata file based on the file storage search request, and returning a search result obtained by the searching to the search server.

According to the present invention, it is possible to easily and appropriately search for a file from a plurality of file storages.

### BRIEF DESCRIPTION OF THE DRAWINGS

FIG. 1 is a diagram for explaining an outline of a first embodiment;

FIG. 2 is a diagram illustrating an entire configuration of a computer system according to the first embodiment;

FIG. 3 is a configuration diagram of an example of a file storage according to the first embodiment;

FIG. 4 is a configuration diagram of an example of a search server according to the first embodiment;

FIG. 5 is a configuration diagram of an example of a metadata file list according to the first embodiment;

FIG. 6 is a configuration diagram of an example of a metadata file according to the first embodiment;

FIG. 7 is a configuration diagram of an example of an operation log list according to the first embodiment;

FIG. 8 is a configuration diagram of an example of a file storage list according to the first embodiment;

FIG. 9 is a configuration diagram of an example of a data search result according to the first embodiment;

FIG. 10 is a flowchart of an example of search processing according to the first embodiment;

FIG. 11 is a flowchart of an example of file I/O processing according to the first embodiment;

FIG. 12 is a flowchart of an example of metadata file update processing according to the first embodiment;

FIG. 13 is a flowchart illustrating an example of snapshot acquisition processing according to the first embodiment;

FIG. 14 is a flowchart illustrating an example of snapshot delete processing according to the first embodiment;

FIG. 15 is a diagram for explaining an outline of a second embodiment;

FIG. 16 is a configuration diagram of an example of a file storage according to the second embodiment;

FIG. 17 is a flowchart of an example of search processing according to the second embodiment;

FIG. 18 is a flowchart of an example of local search processing according to the second embodiment;

FIG. 19 is a configuration diagram of an example of a file storage according to a third embodiment;

FIG. 20 is a configuration diagram of an example of a search server according to the third embodiment;

FIG. 21 is a flowchart of an example of search processing according to the third embodiment; and

FIG. 22 is a flowchart of an example of metadata transmission processing according to the third embodiment.

### DESCRIPTION OF THE PREFERRED EMBODIMENTS

Embodiments will be described with reference to the drawings. Further, the embodiments described below do not limit the scope of the invention. Not all the elements and combinations thereof described in the embodiments are essential to the solution of the invention.

In the following description, a data structure of information may be described as a table, but the information may be expressed by any data structure.

In addition, in the following description, a process may be described to be performed by a “program”. The program is performed by the processor, and a designated process is performed appropriately using at least one of a storage unit and an interface unit. Therefore, the subject of the process may be the processor (or a computer or a computer system which includes the processor). The program may be installed in the computer from a program source. The program source may be, for example, a program distribution server or a computer-readable recording medium. In addition, in the following description, two or more programs may be expressed as one program, or one program may be expressed as two or more programs. In addition, at least a part of the processing realized by executing the program may be realized by a hardware circuit (for example, an application specific integrated circuit (ASIC) or a field-programmable gate array (FPGA) is used).

### First Embodiment

In the computer system of the first embodiment, a search server that provides global data search (that is, the data search for the file storage of the plurality of sites is performed) performs data search on a metadata file on each file storage using an interface (single-file search request: e.g. S3select in Amazon S3 (registered trademark)) for searching with SQL for a single file, thereby implementing global data search.

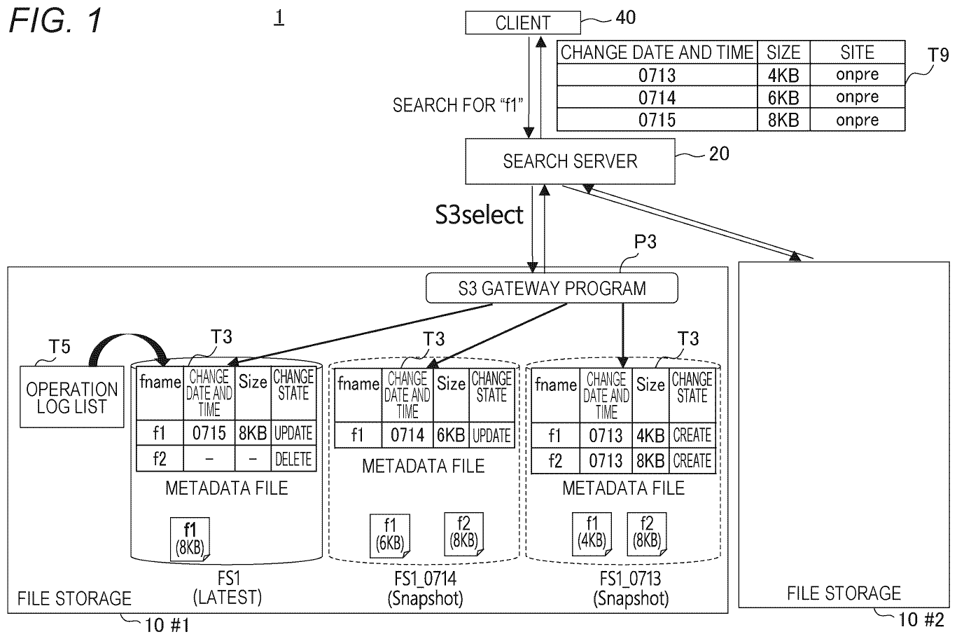

FIG. 1 is a diagram illustrating an outline of a first embodiment.

A client 40 requests a search server 20 to perform global data search. As the search condition, metadata about a file such as a file name, a directory name, a file size, a creation date and time, and a change date and time, and/or a site and a file storage can be specified. FIG. 1 illustrates an example in which the client 40 requests a search for a file having a file name “f1”.

The search server 20 receives a search request from the client 40, searches the metadata file (second metadata file) of each file system of each file storage 10 or the metadata file (first metadata file) corresponding to the snapshot of the file system using S3select based on the received search request, receives the search result from each file storage 10, aggregates the search result, and returns the search result to the client 40.

In the example of FIG. 1, the search server 20 searches metadata files T3 of a file system FS1 of the file storage 10 (file storage #1) and FS1_0714 and FS1_0713 which are snapshots of the file system FS1 using S3select.

The file storage 10 includes an S3 gateway program P3, and the S3 gateway program P3 can process a request of S3select. Further, the file storage 10 holds a file I/O operation to the file system (FS1 or the like) as an operation log list T5, and creates the metadata file T3 based on the operation log list T5. In the metadata file T3, metadata of a file of the file system is stored in a format that can be searched by a request of S3select. When a snapshot is obtained, the file storage 10 stores metadata that is a difference from the metadata file T3 of the previous snapshot in the metadata file T3 of a subsequent snapshot (incremental snapshot) or a file system (parent file system) from which the snapshot is acquired.

In the example of FIG. 1, metadata about the created files f1 and f2 is stored in the metadata file T3 of the snapshot of FS1_0713. In the snapshot of FS1_0714 which is an incremental snapshot of FS1_0713, only metadata of the file f1 which is a difference from the snapshot of FS1_0713 is stored. The metadata file T3 of the file system FS1 stores metadata of the files f1 and f2 which is a difference from the snapshot of FS1_0714.

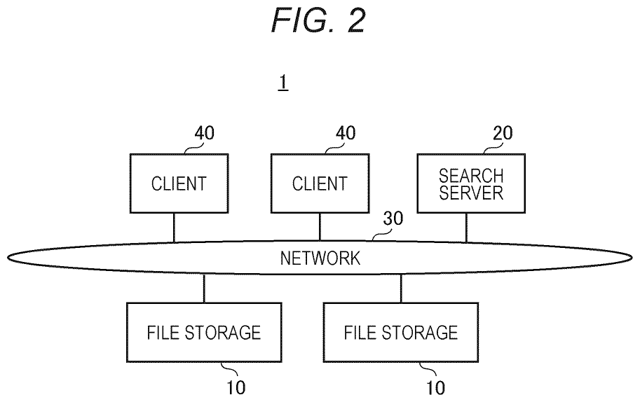

FIG. 2 is a diagram illustrating an entire configuration of a computer system according to the first embodiment.

A computer system 1 includes one or more clients 40, a search server 20, and a plurality of file storages 10. The client 40, the search server 20, and the file storage 10 are connected via a network 30.

The network 30 is, for example, a Wide Area Network (WAN) and a Local Area Network (LAN).

The client 40 is a device used by a user who searches for a desired file from the plurality of file storages 10, transmits a search condition to the search server 20, receives a search result from the search server 20, and displays the search result. The client 40 includes, for example, a computer such as a personal computer (PC).

The file storage 10 is a device that manages a file system that manages data as a file (content). The file storage 10 may be configured by, for example, a single storage device, or may be a distributed file storage configured by a plurality of storage devices. The storage device may be, for example, a dedicated storage device, or may be, for example, a storage device including a PC or a general-purpose server.

The search server 20 receives a search request from the client 40, controls search processing of files managed in the plurality of file storages 10 based on the search request, and returns a search result to the client 40.

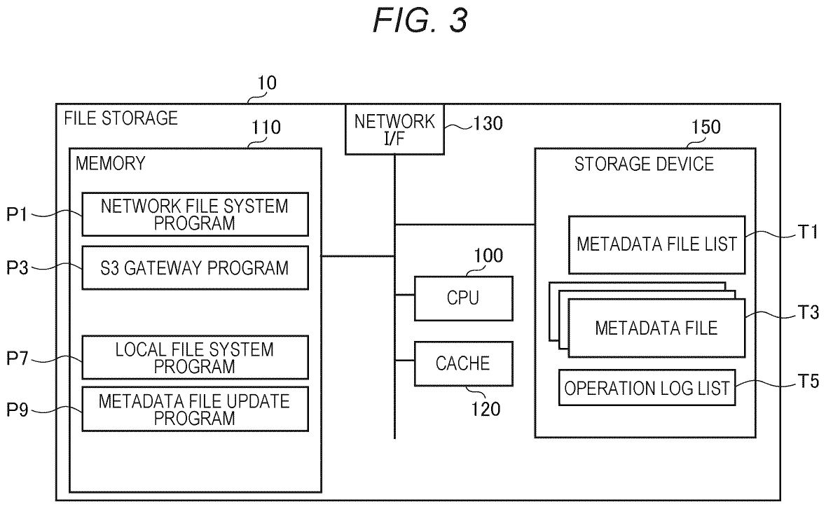

FIG. 3 is a configuration diagram of an example of the file storage according to the first embodiment.

The file storage 10 is a file storage that manages data as a file (content). The file storage 10 includes, for example, a computer, and includes a central processing unit (CPU) 100 as an example of a processor, a memory 110, a cache 120, a network I/F 130, and a storage device 150. The CPU 100, the memory 110, the cache 120, the network I/F 130, and the storage device 150 are mutually connected via a communication path such as a bus, for example.

The CPU 100 controls the operation of the file storage by executing the program stored in the memory 110.

The memory 110 is, for example, a random access memory (RAM), and temporarily stores programs and data necessary for operation control of the CPU 100. The memory 110 stores a network file system program P1, an S3 gateway program P3, a local file system program P7, and a metadata file update program P9. Note that the program stored in the memory 110 may be stored in the storage device 150.

The network file system program P1 is executed by the CPU 100 to receive various operation requests such as Read/Write to the file system from the client 40 or the like, and processes the protocol included in the operation request. For example, the network file system program P1 processes protocols such as Native-Client, FUSE (Filesystem in Userapace), NFS (Network File System), and SMB (Server Message Block).

The S3 gateway program P3 is executed by the CPU 100 to receive various requests of an S3 application programming interface (API) from the client 40, the search server 20, and the like, and execute processing according to the received request. The S3API also includes S3select.

The local file system program P7 is executed by the CPU 100 to provide a content storage such as a file system and an object storage to the network file system program P1 and the S3 gateway program P3. The local file system program P7 is executed by the CPU 100 to additionally write the operation content for the content storage in the operation log list T5.

The metadata file update program P9 is executed by the CPU 100 to create or update the metadata file T3 based on the operation log list T5.

The cache 120 is, for example, a RAM, and temporarily stores data written from the client 40 and data read from the storage device 150.

The network I/F 130 is, for example, an interface such as a wired LAN card or a wireless LAN card, and communicates with other devices (for example, the client 40 or the search server 20) via the network 30.

The storage device 150 is, for example, a hard disk, a flash memory, or the like, and stores various kinds of content including content used by the user of the client 40. The storage device 150 stores a metadata file list T1, a metadata file T3, and an operation log list T5. In addition to the storage device 150 or instead of the storage device 150, a block storage connected to the file storage 10 may be used. The block storage may provide the file storage 10 with a storage function in a block format such as Fibre Channel Storage Area Network (FC-SAN). Further, the storage device 150 may hierarchize data into object storage or block storage.

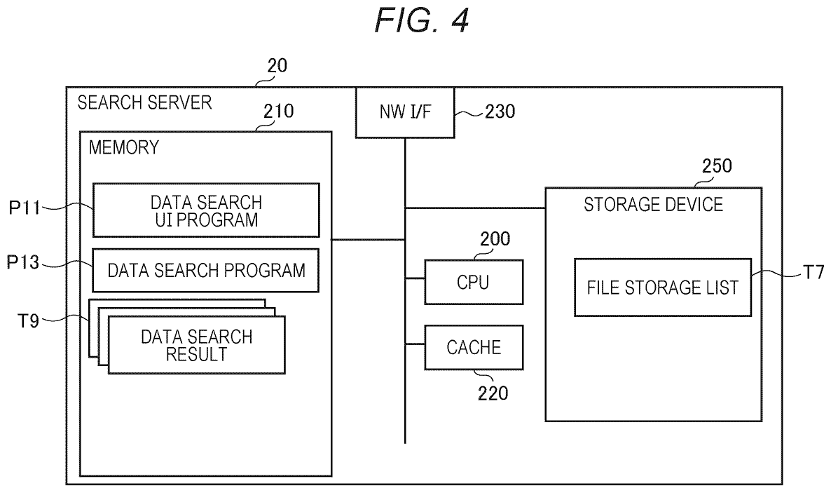

FIG. 4 is a configuration diagram of an example of a search server according to the first embodiment.

The search server 20 provides a user interface (UI) for data search to the client 40, and searches for data stored in the plurality of file storages 10 in response to a request from the client 40. The search server 20 includes, for example, a computer such as a PC or a general-purpose server. The search server 20 includes a CPU 200 as an example of a processor, a memory 210, a cache 220, a network I/F 230, and a storage device 250. The CPU 200, the memory 210, the cache 220, the network I/F 230, and the storage device 250 are mutually connected via a communication path such as a bus, for example.

The CPU 200 controls the operation of the search server 20 by executing the program stored in the memory 210.

The memory 210 is, for example, a RAM, and temporarily stores programs and data necessary for operation control of the CPU 200. The memory 210 stores a data search UI program P11, a data search program P13, and a data search result T9. Note that the program stored in the memory 210 may be stored in the storage device 250.

The data search UI program P11 is executed by the CPU 200 to provide a data search UI to the client 40, and receives a data search request from the client 40.

The data search program P13 is executed by the CPU 200 to issue S3select corresponding to the data search request from the client 40 to each file storage 10.

The cache 220 is, for example, a RAM, and temporarily stores a search result in response to a data search request from the client 40 and data read from the storage device 250.

The network I/F 230 is, for example, an interface such as a wired LAN card or a wireless LAN card, and communicates with other devices (for example, client 40, file storage 10) via the network 30.

The storage device 250 is, for example, a hard disk, a flash memory, or the like, and stores an operating system of the search server 20, a file storage list T7, or the like.

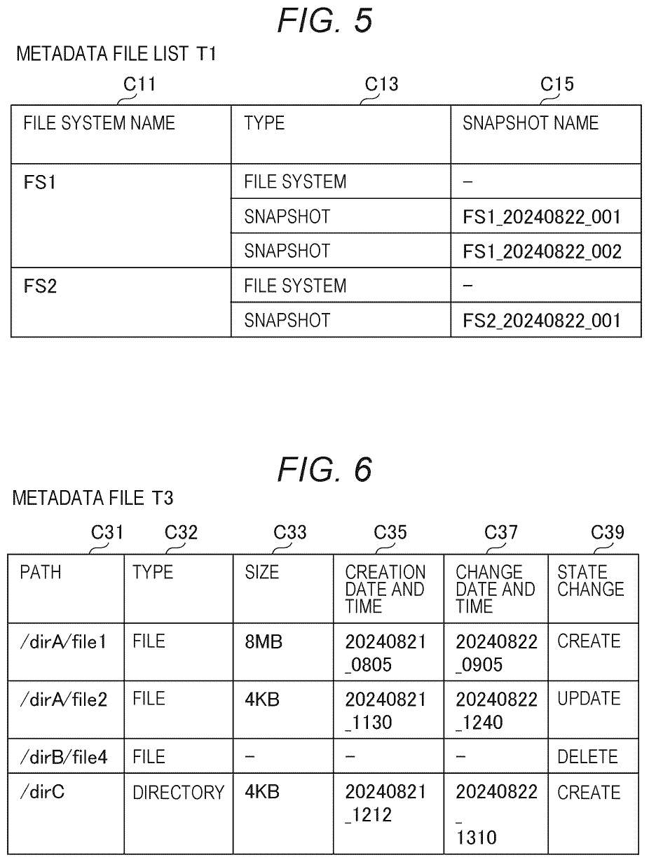

FIG. 5 is a diagram illustrating an example of a metadata file list according to the first embodiment.

The metadata file list T1 is a table that stores information of a file system in the file storage 10 and a metadata file corresponding to a snapshot of the file system. The metadata file list T1 stores entries corresponding to the metadata files T3 of the file system and the snapshot. The entry of the metadata file list T1 includes fields of a file system name C11, a type C13, and a snapshot name C15.

The file system name C11 stores a file system name corresponding to the metadata file corresponding to the entry. For example, when the metadata file corresponding to the entry is a snapshot, a file system name of a file system (parent file system) that is a base of the snapshot is stored in the file system name C11.

The type C13 stores a type name indicating which of a file system and a snapshot of the file system the metadata file corresponding to the entry corresponds to.

In the snapshot name C15, a snapshot name corresponding to the metadata file corresponding to the entry is stored. When the metadata file corresponding to the entry is the metadata file about the file system, “-” indicating that there is no data is stored in the snapshot name C15.

In the present embodiment, the path of the metadata file corresponding to each entry can be specified according to, for example, a predetermined rule, a value of the entry, or the like. For example, the metadata file on the first line may be FS1/metadata file, and the metadata file on the second line may be FS1/Snap/FS1_20240822_001/metadata file. Each entry may include a field for storing the path name of the metadata file.

FIG. 6 is a diagram illustrating an example of a metadata file according to the first embodiment.

The metadata file T3 is created for each file system or snapshot. The metadata file T3 stores metadata about a file or a directory as an entry. In the present embodiment, the metadata file T3 is configured in a format that can be searched by S3select such as CSV, JSON, and Apache Parquet, for example.

The entry of the metadata file T3 includes fields of a path C31, a type C32, a size C33, a creation date and time C35, a change date and time C37, and a state change C39. Note that the entry may include other metadata such as an access right.

The path C31 stores a path of a file or a directory corresponding to the entry. The type C32 stores a flag indicating whether the entry corresponds to a file or a directory. The size C33 stores the size of the file or the directory corresponding to the entry. The creation date and time C35 stores the date and time when the file or the directory corresponding to the entry is created.

The change date and time C37 stores the date and time when the file or directory corresponding to the entry has been last changed. The state change C39 stores a state change from the state of the previous snapshot for the file or directory corresponding to the entry. The state change C39 stores creation, update, or deletion as the state change. The creation indicates that a file or a directory that has not existed in the previous snapshot is created. The update indicates that the file or directory existing in the previous snapshot has been updated. The deletion indicates that a file or a directory existing in the previous snapshot has been deleted.

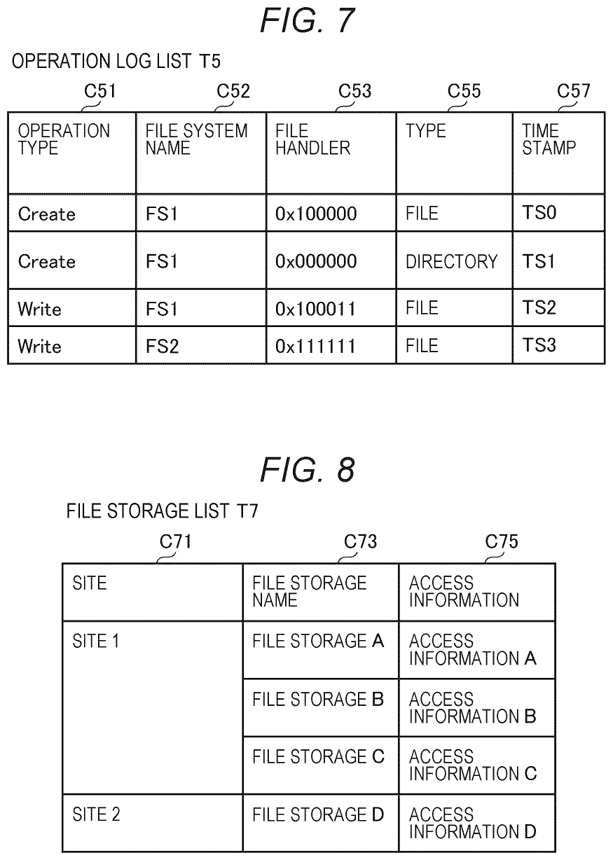

FIG. 7 is a diagram illustrating an example of an operation log list according to the first embodiment.

The operation log list T5 stores an entry (log) for each file I/O operation. The file I/O operation includes an operation on a file or a directory as an operation target. The entry of the operation log list T5 includes fields of an operation type C51, a file system name C52, a file handler C53, a type C55, and a time stamp C57.

The operation type C51 stores the operation type of the file I/O corresponding to the entry. Examples of the operation type include Create, Write, and Delete. The file system name C52 stores a file system name to which an operation target (file or directory) corresponding to the entry belongs. The file handler C53 stores a file handler, which is an operation target, corresponding to the entry.

The type C55 stores a type name of the type to be operated corresponding to the entry, that is, a value indicating a file or a directory. The time stamp C57 stores information indicating the time when the operation corresponding to the entry is performed.

FIG. 8 is a diagram illustrating an example of a file storage list according to the first embodiment;

The file storage list T7 is a table that stores access information for accessing each file storage 10 existing in a plurality of sites. The file storage list T7 stores an entry for each file storage 10. The entry of the file storage list T7 includes fields of a site C71, a file storage name C73, and access information C75.

In the site C71, the name (site name) of the site in which the file storage 10 corresponding to the entry exists is stored. The file storage name C73 stores the name (file storage name) of the file storage 10 corresponding to the entry. The access information C75 stores information (access information) for accessing the file storage 10 corresponding to the entry. The access information is, for example, an IP address, a user name, a password, or the like.

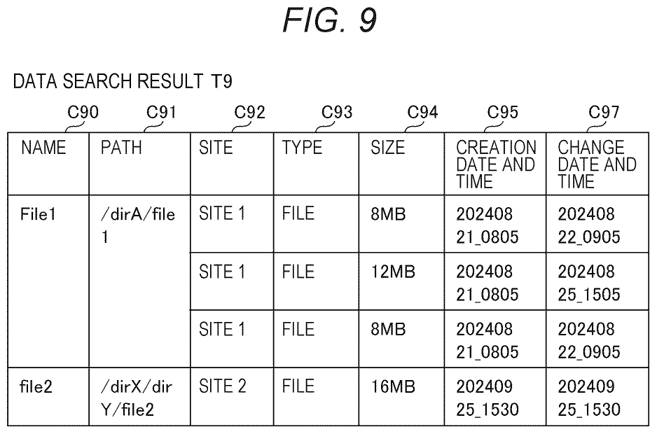

FIG. 9 is a diagram illustrating an example of a data search result according to the first embodiment.

The data search result T9 is a search result for the data search request of the client 40. The data search result T9 includes, for example, an entry for a search result (file or directory). The entry of the data search result T9 includes fields of a name C90, a path C91, a site C92, a type C93, a size C94, a creation date and time C95, and a change date and time C97.

The name C90 stores the name of the result corresponding to the entry. The full path of the result corresponding to the entry is stored in the path C91. In the site C92, the site name of the site of the file storage 10 storing the result corresponding to the entry is stored. The type C93 stores a type name for the result corresponding to the entry. The size C94 stores the size of the result corresponding to the entry. The creation date and time C95 stores the date and time when the result corresponding to the entry has been created. The change date and time C97 stores the date and time when the result corresponding to the entry has been last changed.

Next, a processing operation in the computer system 1 will be described in detail.

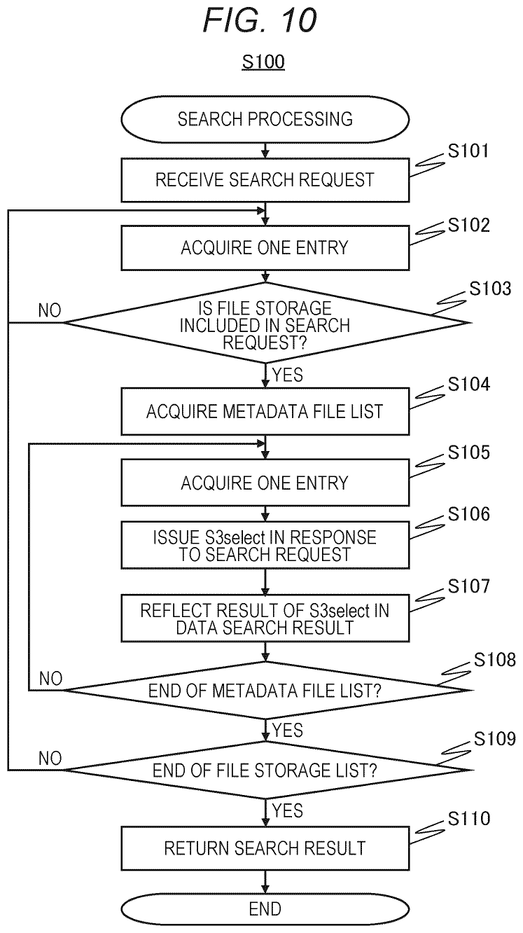

FIG. 10 is a flowchart illustrating an example of search processing according to the first embodiment.

The search processing S100 is performed by the CPU 200 executing the data search UI program P11 and the data search program P13 in the search server 20.

The data search UI program P11 (strictly speaking, the CPU 200 that executes the data search UI program P11) causes the client 40 to display the data search UI, receives a global data search request capable of setting the plurality of file storages 10 as the search target range from the client 40 via the data search UI, and requests the data search program P13 to perform data search according to the global data search request (S101). Here, the global data search request can include a condition for filtering the site or the file storage 10 as the data search target.

When receiving the data search request, the data search program P13 acquires one unprocessed entry from the file storage list T7 (S102).

The data search program P13 confirms the site name of the site C71 of the entry acquired from the file storage list T7 and the file storage name of the file storage name C73, and confirms whether the file storage 10 corresponding to the entry is included in the range of the data search request (S103).

As a result, in a case where the file storage corresponding to the entry is included in the search range (S103: Yes), the processing proceeds to step S104, and in a case where the file storage corresponding to the entry is not included (S103: No), the processing proceeds to step S102. In this process, it is possible not to perform the search request to the file storage 10 in the site that is not set as the search target range in the global data search request.

In step S104, the data search program P13 refers to the access information of the access information C75 of the entry acquired from the file storage list T7, and acquires the metadata file list T1 of the target file storage from the file storage 10 (in the description of this process, it is referred to as target file storage) corresponding to this entry using the access information (S104).

The data search program P13 acquires one unprocessed entry from the acquired metadata file list T1 (S105).

The data search program P13 issues S3select (an example of a file storage search request) corresponding to the search request to the metadata file T3 corresponding to the acquired entry to the target file storage (S106).

As a result, in the target file storage, the S3 gateway program P3 acquires S3select, searches the metadata file T3 according to the acquired S3select, and transmits the search result to the search server 20.

The data search program P13 acquires a search result by S3select from the target file storage and reflects the acquired search result in the data search result T9 (S107). Specifically, the data search program P13 adds an entry to the data search result T9 and stores the acquired search result, the file name, and the site information in the entry. For example, in a case where a plurality of versions of a certain file is included in the search result, an entry of each version of the same path is added to the data search result T9.

Next, the data search program P13 confirms whether the entry acquired from the metadata file list T1 in step S105 is a last entry (S108). As a result, in a case where the entry is the last entry (S108: Yes), the processing proceeds to step S109, and in a case where the entry is not the last entry (S108: No), the processing proceeds to step S105, and the processing for the next entry is performed.

In step S109, the data search program P13 confirms whether the entry acquired from the file storage list T7 in step S102 is the last entry. As a result, in a case where the entry is the last entry (S109: Yes), the processing proceeds to step S110, and in a case where the entry is not the last entry (S109: No), the processing proceeds to step S102, and the processing for the next entry is performed.

In step S110, the data search program P13 returns the data search result T9 to the data search UI program P11, and the data search UI program P11 displays the data search result in a format easy for the user to understand to the client 40 as the request source based on the data search result T9.

According to this search processing, each file storage 10 is caused to execute a search without directly searching data in the search server 20, so that the processing load of the search server 20 can be reduced. Therefore, for example, in a case where the search server 20 is configured in a public cloud, it is possible to reduce the cost required to execute processing in the public cloud. In addition, since the search processing is executed by the plurality of file storages 10, the search processing time can be reduced. In addition, in each file storage 10, SQL (in this example, S3select) for a single file only needs to be executed, so that a processing load is low and a processing time related to search can be shortened.

Next, a processing operation in the file storage 10 will be described in detail.

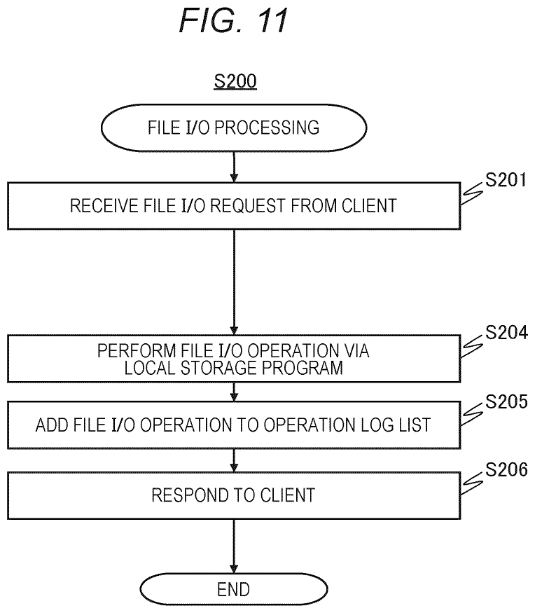

FIG. 11 is a flowchart illustrating an example of file I/O processing according to the first embodiment.

The file I/O processing S200 is performed by the CPU 100 executing the network file system program P1 and the local file system program P7 in the file storage 10.

When the file I/O request is transmitted from the client 40, the network file system program P1 performs protocol processing to accept the file I/O request, and requests the local file system program P7 for a file I/O operation corresponding to the file I/O request (S201).

The local file system program P7 executes the file I/O operation requested to the file system (S204).

Next, the local file system program P7 adds the content of the executed file I/O operation to the operation log list T5 (S205).

Then, the local file system program P7 returns the operation result to the network file system program P1, and the network file system program P1 responds to the client 40, that is, returns the operation result (S206).

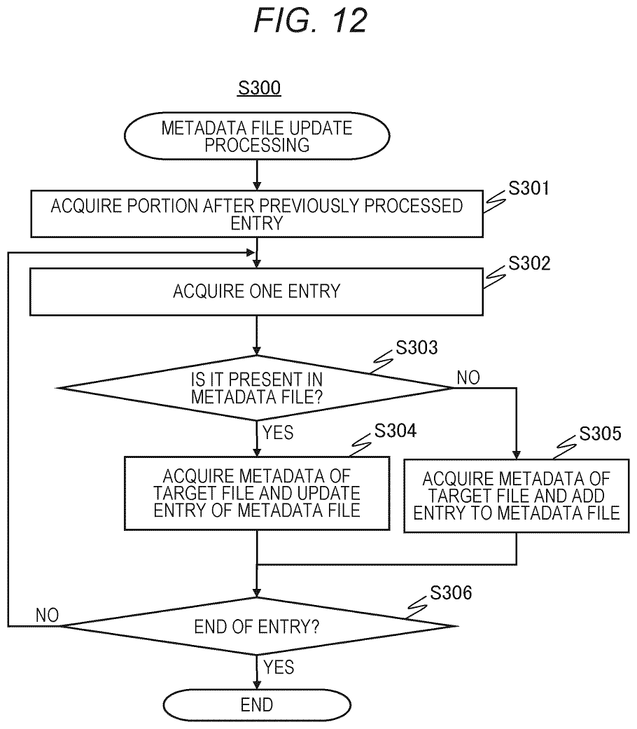

FIG. 12 is a flowchart illustrating an example of metadata file update processing according to the first embodiment.

The metadata file update processing S300 is periodically executed at an interval (for example, 1 minute, 5 minutes, etc.) shorter than an interval at which snapshots are periodically acquired, or is executed in the snapshot acquisition processing S400 described later, for example. The metadata file update processing S300 is performed by the CPU 100 executing the metadata file update program P9 in the file storage 10.

The metadata file update program P9 acquires a portion after the entry processed in the previous metadata file update processing S300 from the operation log list T5 (S301). Here, in the following description of processing, an acquired portion of the operation log list T5 is referred to as an acquisition log list. Note that, for a portion after the entry processed in the previous metadata file update processing, for example, a time stamp when the metadata file update processing is executed may be stored and specified based on the time stamp.

Next, the metadata file update program P9 acquires one unprocessed entry from the acquisition log list (S302).

Next, the metadata file update program P9 acquires a path from the file system name of the file system name C52 of the acquired entry and the file handler of the file handler C53, and confirms whether the acquired path exists in the metadata file T3 (in the description of this processing, the target metadata file is referred to as a target metadata file) of the file system (note that, in a case where the processing is executed in the snapshot acquisition processing S400, a snapshot to be created is obtained) having the file system name C52 (S303). As a result, in a case where the acquired path exists in the target metadata file (S303: Yes), the processing proceeds to step S304, and in a case where the acquired path does not exist (S303: No), the processing proceeds to step S305.

In step S304, the metadata file update program P9 acquires the metadata of the file (referred to as a target file in the description of the processing) corresponding to the acquired path, and updates the information of the entry of the target file of the target metadata file. For example, when the operation type C51 of the entry is Create, the state change C39 of the entry of the target file of the target metadata file is updated to “Create”. When the operation type C51 of the entry is Create, only “Delete” can exist as the state change C39 of the entry of the existing target file. When the operation type C51 is Write, the state change C39 of the entry of the target file of the target metadata file is not updated. This is because, when the state change C39 of the existing entry is “Create”, overwriting with “Update” makes it impossible to determine whether the target file has been created at the time of this version. When the processing in step S304 or step S305 has already been performed on the target file in metadata file update processing S300, the processing in step S304 may be skipped. In addition, in a case where the operation type C51 is Delete, the information of the size C33, the creation date and time C35, and the change date and time C37 of the entry of the target file is deleted, and the state change C39 is updated to “Delete”.

In step S305, the metadata file update program P9 acquires the metadata of the target file, and adds an entry about the target file to the target metadata file. Here, when the operation type C51 is Create, the state change C39 of the entry is “Create”, when the operation type is Write, the state change C39 is “Update”, and when the operation type is Delete, the state change C39 is “Delete”.

After executing step S304 or step S305, the metadata file update program P9 confirms whether the entry acquired in step S302 is a last entry of the acquisition log list (S306). As a result, when the entry is the last entry (S306: Yes), the processing of the metadata file update program P9 ends, and when the entry is not the last entry (S306: No), the metadata file update program P9 advances the processing to step S302 and executes the processing on the next entry.

According to the metadata file update processing, the latest metadata about the file can be stored in the metadata file T3.

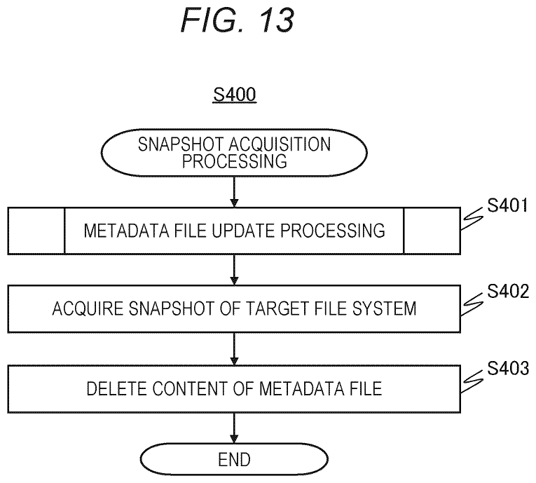

FIG. 13 is a flowchart illustrating an example of snapshot acquisition processing according to the first embodiment.

The snapshot acquisition processing S400 is performed in response to a snapshot acquisition request from the client 40 or a time point according to the snapshot acquisition setting (for example, a setting for performing periodic acquisition every day or the like). The snapshot acquisition processing S400 is performed by the CPU 100 executing the network file system program P1 in the file storage 10.

The network file system program P1 performs the metadata file update processing S300 (S401).

Next, the network file system program P1 acquires a snapshot of a file system (target file system) for which the snapshot is to be acquired (S402).

Next, the network file system program P1 deletes the content of the metadata file T3 of the target file system (S403). This is because only metadata that is a difference from the state of the snapshot of the previous version is stored in the metadata file T3.

For steps S401 and S402, step S402 may be executed first, and then step S401 may be executed. However, in this case, in step S401, the log up to the acquisition of the snapshot in step S402 in the operation log list T5 is referred to, and the metadata file T3 corresponding to the snapshot is updated.

According to this snapshot acquisition processing, metadata such as a file that is a difference from the state of the previous snapshot can be stored in the metadata file T3 corresponding to the acquired snapshot.

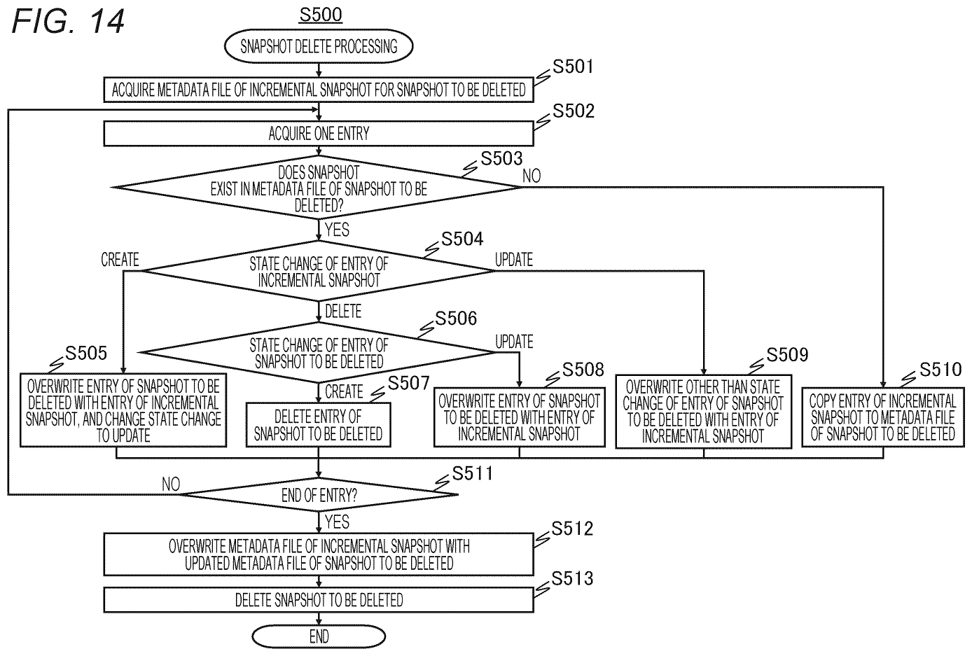

FIG. 14 is a flowchart illustrating an example of snapshot delete processing according to the first embodiment.

The snapshot delete processing S500 is executed in response to a snapshot delete request from the client 40 or a time point according to the snapshot delete setting (for example, setting to periodically perform deletion). The snapshot delete processing S500 is performed by the CPU 100 executing the network file system program P1 in the file storage 10.

The network file system program P1 acquires the metadata file T3 corresponding to a snapshot (referred to as an incremental snapshot) immediately after the snapshot to be deleted (snapshot to be deleted) (S501).

Next, the network file system program P1 acquires one unprocessed entry from the acquired metadata file T3 (S502).

Next, the network file system program P1 confirms whether the path of the path C31 of the acquired entry exists in the metadata file T3 of the snapshot to be deleted (S503). As a result, when the path of the path C31 of the acquired entry exists in the metadata file T3 of the snapshot to be deleted (S503: Yes), the network file system program P1 advances the processing to step S504 and performs processing of updating the entry of the metadata file T3 of the snapshot to be deleted. On the other hand, when the path of the path C31 of the acquired entry does not exist in the metadata file T3 of the snapshot to be deleted (S503: No), the network file system program P1 advances the processing to step S510.

In step S504, the network file system program P1 confirms the state change C39 of the entry acquired in step S502. As a result, when the state change C39 is “Create” (S504: Create), the network file system program P1 advances the processing to step S505. When the state change C39 is “Delete” (S504: Delete), the network file system program P1 advances the processing to step S506. When the state change C39 is “Update” (S504: Update), the network file system program P1 advances the processing to step S509.

In step S505, the network file system program P1 overwrites the corresponding entry of the metadata file T3 of the snapshot to be deleted with the entry acquired in step S502. At this time, the state change C39 of the entry is overwritten as “Update”. This is because, when the state change C39 of the entry acquired in step S502 is “Create”, only “Delete” can occur as the state change C39 of the entry of the snapshot to be deleted, and when the snapshot to be deleted is deleted, there is no deletion.

In step S506, the network file system program P1 confirms the state change C39 of the entry of the metadata file T3 of the snapshot to be deleted corresponding to the entry of the metadata file T3 of the incremental snapshot. As a result, when the state change C39 is “Create”(S506: Create), the network file system program P1 advances the processing to step S507. On the other hand, when the state change is “Update” (S506: Update), the network file system program P1 advances the processing to S508. Note that, in this case, the state change C39 is not “Delete”.

In step S507, the network file system program P1 deletes the entry of the metadata file T3 of the snapshot to be deleted corresponding to the entry of the metadata file T3 of the incremental snapshot.

In step S508, the network file system program P1 overwrites the entry of the metadata file T3 of the snapshot to be deleted with the entry of the metadata file T3 of the incremental snapshot.

In step S509, the network file system program P1 overwrites the entry of the metadata file T3 of the snapshot to be deleted with the entry of the metadata file T3 of the incremental snapshot. However, the state change C39 of the entry is not overwritten.

In step S510, the network file system program P1 copies the entry of the metadata file T3 of the incremental snapshot to the metadata file T3 of the snapshot to be deleted.

After executing steps S505 and S507 to S510, the network file system program P1 confirms whether the entry acquired in step S502 is the last entry of the metadata file T3 of the incremental snapshot (S511).

As a result, when the entry is the last entry of the metadata file T3 (S511: Yes), the network file system program P1 advances the processing to step S512. On the other hand, when the entry is not the last entry of the metadata file T3 (S511: No), the network file system program P1 advances the processing to step S502, and executes the processing on the next entry.

In step S512, the network file system program P1 sets the metadata file T3 of the updated snapshot to be deleted as a new metadata file T3 of the incremental snapshot (S512).

Next, the network file system program P1 deletes the snapshot to be deleted (S513).

According to the snapshot delete processing S500, when deleting a snapshot, the metadata file T3 of an incremental snapshot can be brought into an appropriate state.

### Second Embodiment

Next, a second embodiment will be described. In a computer system 1A according to the second embodiment, a local search program P5 of a file storage 10A issues S3select in the file storage. As a result, communication across sites between the search server 20 and each file storage 10A is reduced, and the load on the search server 20 can be reduced. In the second embodiment, the same reference numerals are given to the same parts as those in the first embodiment, and redundant description may be omitted.

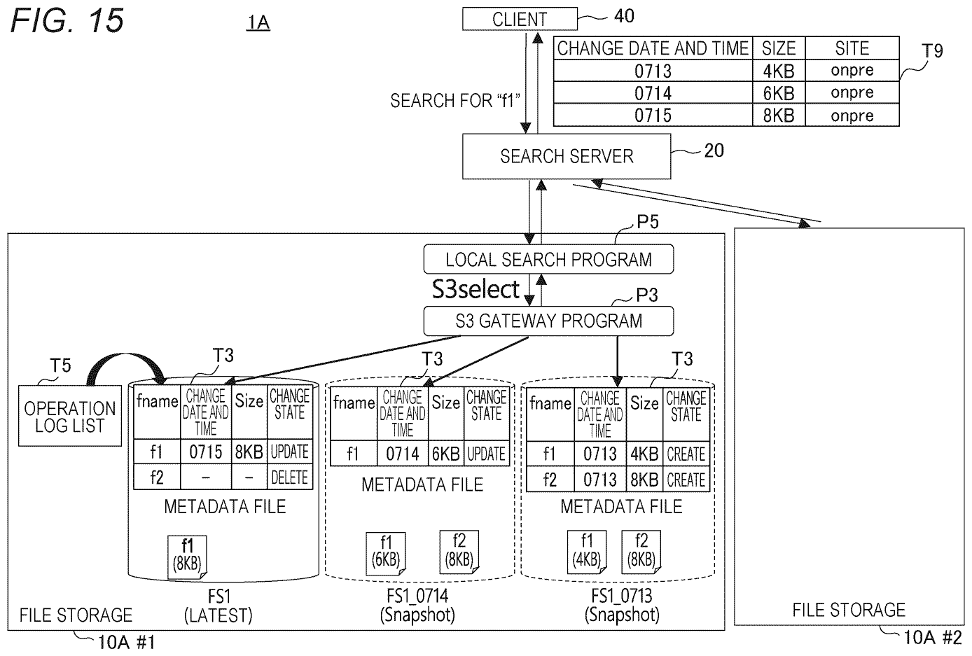

FIG. 15 is a diagram illustrating an outline of the second embodiment. In the second embodiment, the same reference numerals are given to the same parts as those in the first embodiment, and redundant description may be omitted.

The second embodiment is different from the first embodiment illustrated in FIG. 1 in that the search server 20 transfers the search request based on the search request of the client 40 to each file storage 10A without issuing S3select, and the local search program P5 of each file storage 10A issues S3select for each metadata file T3 in the file storage 10A to perform search.

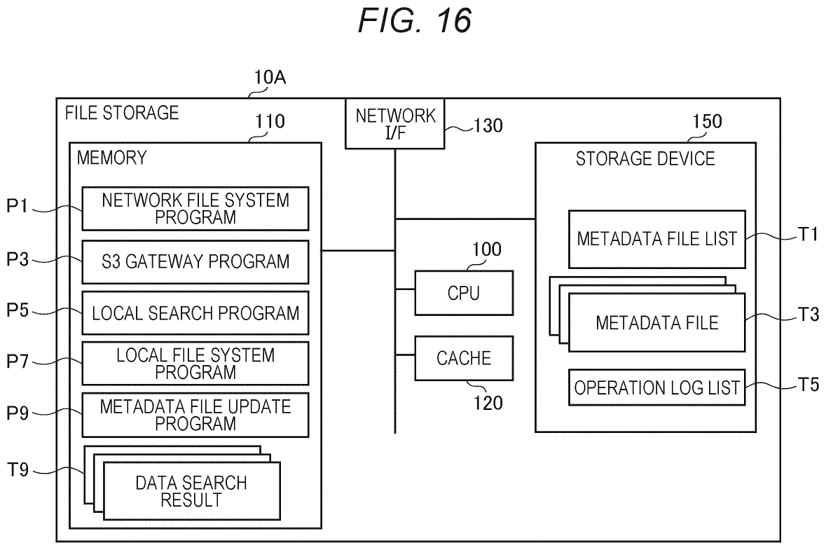

FIG. 16 is a configuration diagram illustrating an example of a file storage according to the second embodiment.

The file storage 10A according to the second embodiment further stores the local search program P5 and the data search result T9 in the memory 110 of the file storage 10 according to the first embodiment.

The local search program P5 is executed by the CPU 100 to receive a data search request from the search server 20 or the like, and performs search processing according to the data search request.

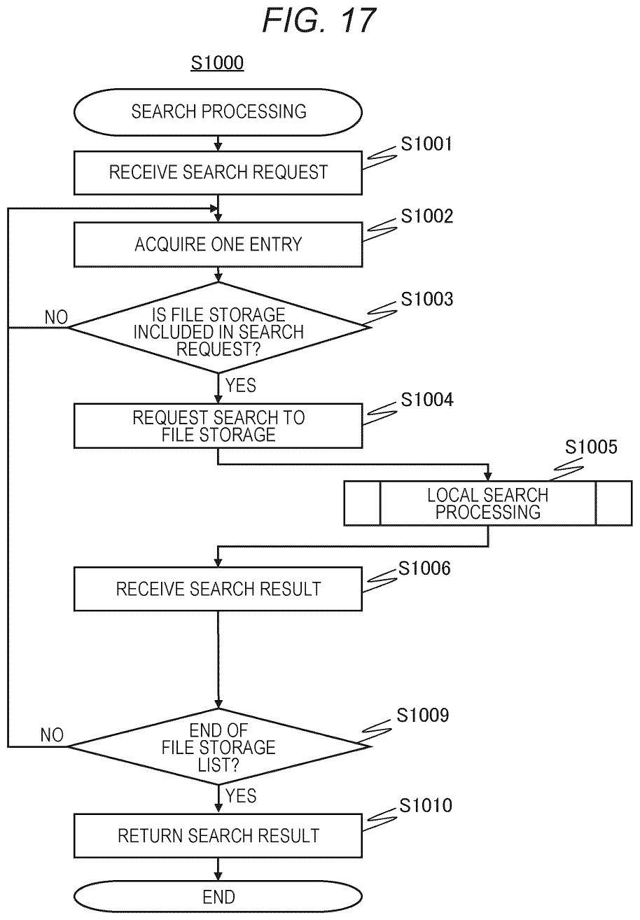

FIG. 17 is a flowchart illustrating an example of search processing according to the second embodiment.

The search processing S1000 is performed by the CPU 200 executing the data search UI program P11 and the data search program P13 in the search server 20 and the CPU 100 executing the local search program P5 in the file storage 10A.

The processing in steps S1001 to S1003 is similar to that in steps S101 to S103 in FIG. 10.

In step S1004, the data search program P13 refers to the access information of the access information C75 of the entry acquired in step S1002, and transmits a search request (file storage search request) corresponding to the data search request from the client 40 to the file storage 10A corresponding to this entry.

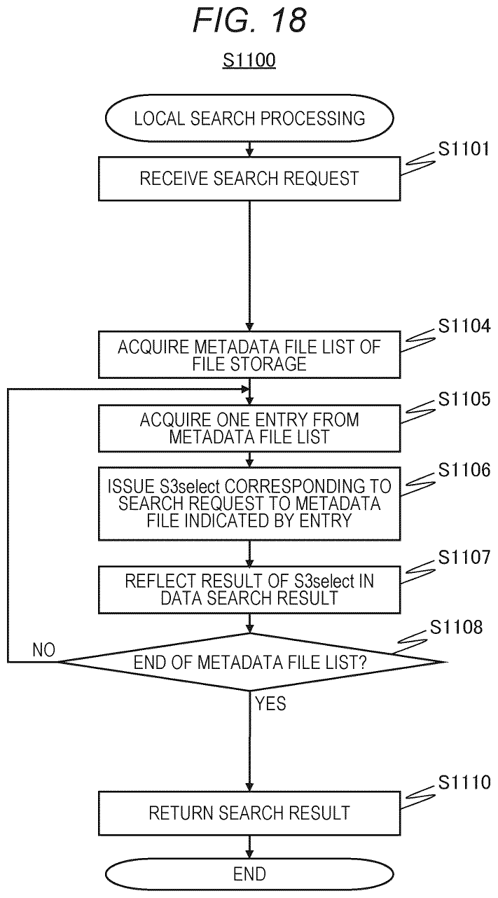

Next, the local search program P5 of the file storage 10A executes local search processing S1100 (see FIG. 18) and returns a search result (S1005).

Next, the data search program P13 receives the search result from the file storage 10A and reflects the search result to the data search result T9 (S1006).

Steps S1009 to S1010 are similar to steps S109 to S110 in FIG. 10.

According to the search processing S1000, each file storage 10 is caused to execute the search without directly searching data in the search server 20, so that the processing load of the search server 20 can be reduced. Therefore, for example, in a case where the search server 20 is configured in a public cloud, it is possible to reduce the cost required to execute processing in the public cloud. In addition, since the search processing is executed by the plurality of file storages 10A, the search processing time can be reduced.

FIG. 18 is a flowchart illustrating an example of local search processing according to the second embodiment.

The local search processing S1100 is performed by the CPU 100 executing the local search program P5 in the file storage 10A.

In step S1101, the local search program P5 receives a search request from the search server 20.

Steps S1104 to S1108 are different in that the local search program P5 executes processing, but the processing content is similar to steps S104 to S108.

In the local search processing S1100, when the local search program P5 issues S3select in step S1106, the S3 gateway program P3 acquires S3select, searches the metadata file T3 according to the acquired S3select, and returns a search result to the local search program P5.

### Third Embodiment

Next, a third embodiment will be described. In the computer system according to the third embodiment, metadata that is a difference is extracted in a file storage 10B, the metadata is transferred to a search server 20B, and the metadata is intensively managed in a database (DB) on the search server 20B. In the third embodiment, the same reference numerals are given to the same parts as those in the first embodiment, and redundant description may be omitted.

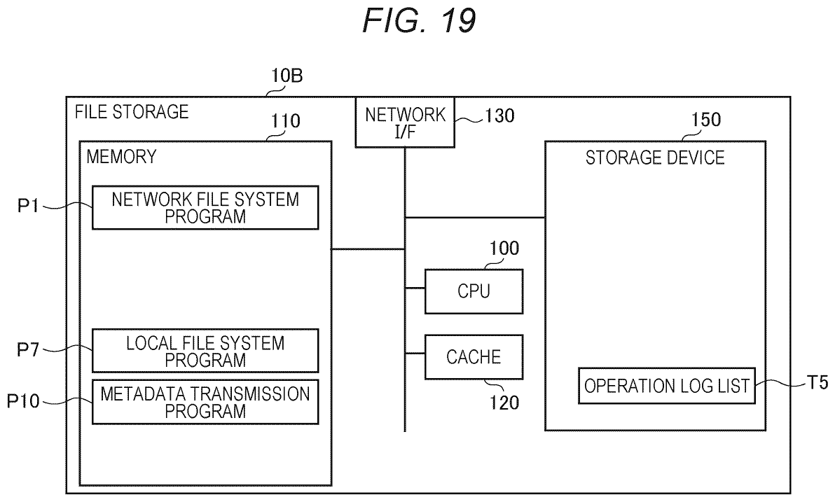

FIG. 19 is a configuration diagram illustrating an example of a file storage according to the third embodiment.

In the file storage 10B according to the third embodiment, the memory 110 stores a metadata transmission program P10 in the file storage 10 according to the first embodiment. The file storage 10B may not include the S3 gateway program P3, the metadata file update program P9, the metadata file list T1, and the metadata file T3.

The metadata transmission program P10 is executed by the CPU 100 to detect the update of the metadata from the operation log list T5 and transmit the metadata to the search server 20B.

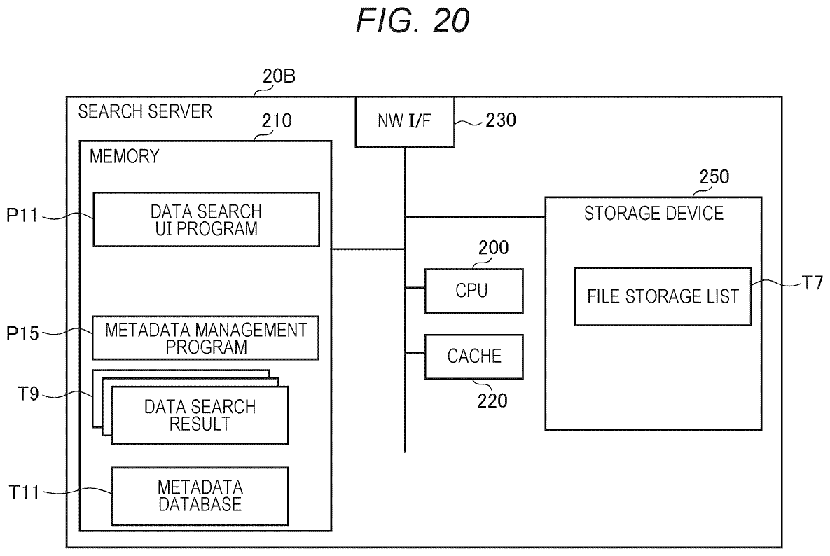

FIG. 20 is a configuration diagram illustrating an example of a search server according to the third embodiment.

The search server 20B according to the third embodiment includes a metadata management program P15 and a metadata database T11 in the search server 20 according to the first embodiment. The search server 20B may not include the data search program P13.

The metadata management program P15 is executed by the CPU 200 to manage the metadata database T11.

The metadata database T11 is a database that manages the metadata collected from each file storage 10.

The entry of the metadata database T11 has a field similar to that of the entry of the data search result T9.

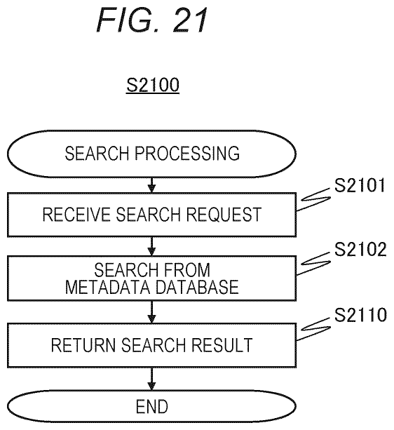

FIG. 21 is a flowchart illustrating an example of search processing according to the third embodiment.

The search processing S2100 is performed by the CPU 200 executing the data search UI program P11 and the metadata management program P15 in the search server 20B.

The data search UI program P11 causes the client 40 to display the data search UI, receives a global data search request capable of setting the plurality of file storages 10 as the search target range from the client 40 via the data search UI, and requests the metadata management program P15 to perform data search according to the global data search request (S2101).

Next, the metadata management program P15 refers to the metadata database T11, executes search in response to the search request, and returns the search result to the data search UI program P11 (S2102).

Next, the data search UI program P11 displays the data search result in a format easy for the user to understand on the client 40 based on the data search result T9 (S2110).

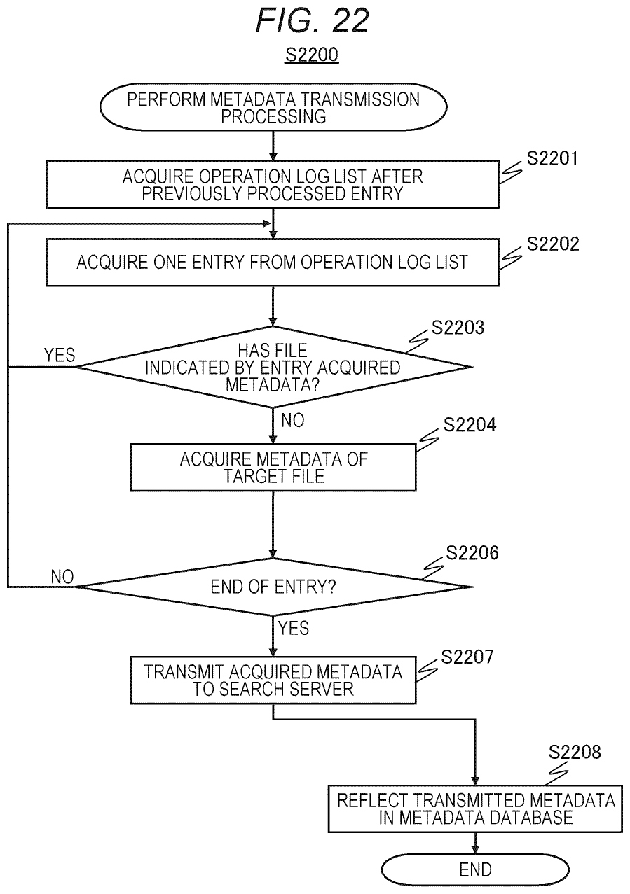

FIG. 22 is a flowchart illustrating an example of metadata transmission processing according to the third embodiment.

The metadata transmission processing S2200 is processing of transmitting and managing metadata about a file system in each file storage 10. The metadata transmission processing S2200 is periodically executed at an interval shorter than an interval at which snapshots are acquired, for example.

The metadata transmission processing S2200 is performed by the CPU 100 executing the metadata transmission program P10 in each file storage 10 and the CPU 200 executing the metadata management program P15 in the search server 20B.

The processing in steps S2201 to S2202 is different from the processing in steps S301 to S302 in FIG. 12 in that the metadata transmission program P10 executes the processing.

In step S2203, the metadata transmission program P10 confirms whether the metadata of the file indicated by the acquired entry has been acquired in the metadata transmission processing S2200.

As a result, when the metadata has been acquired in the metadata transmission processing S2200 (S2203: Yes), the metadata transmission program P10 advances the processing to step S2202. On the other hand, when the metadata has not been acquired in the metadata transmission processing S2200 (S2203: No), the metadata transmission program P10 advances the processing to step S2204.

In step S2204, the metadata transmission program P10 acquires the metadata of the file indicated by the entry.

Next, the metadata transmission program P10 confirms whether the acquired entry is a last entry of the operation log list T5 (S2206).

As a result, when the acquired entry is the last entry of the operation log list T5 (S2206: Yes), the metadata transmission program P10 advances the processing to step S2207, and when the acquired entry is not the last entry of the operation log list T5 (S2206: No), the metadata transmission program P10 advances the processing to step S2202.

In S2207, the metadata transmission program P10 transmits the acquired metadata to the search server 20B. Next, the metadata management program P15 of the search server 20B updates the metadata database T11 based on the delivered metadata (S2208).

According to the metadata transmission processing S2200, metadata such as a file in the file system after the snapshot is acquired can be appropriately reflected in the metadata database T11 of the search server 20B. As a result, the search server 20B can appropriately search for data in the file system after the snapshot is acquired.

Further, the present invention is not limited to the above-described embodiments, and can be implemented in various forms within a scope not departing from the spirit of the present invention.

What is claimed is:

1. A computer system comprising:
a search server; and
a plurality of file storages that manage a file system, wherein
the search server is configured to execute:
accepting a search request for a file to be searched;
transmitting a file storage search request corresponding to the search request to the file storage;
receiving a search result corresponding to the file storage search request from the file storage; and
returning the search result to a request source of the search request, and
the file storage is configured to execute:
storing a first metadata file that stores metadata regarding a file in a snapshot of a file system managed by the file storage;
receiving the file storage search request from the search server;
searching for a file from the first metadata file based on the file storage search request; and
returning a search result obtained by the searching to the search server.

2. The computer system according to claim 1, wherein the file storage creates the first metadata file as a difference from a first metadata file of a previous snapshot.

3. The computer system according to claim 1, wherein
the file storage is configured to execute:
creating a second metadata file that stores metadata related to an operation of a file after acquisition of a previous snapshot in the file system; and
searching for a file from the first metadata file and the second metadata file when accepting the file storage search request.

4. The computer system according to claim 3, wherein
the file storage is configured to execute:
storing a log of a file I/O operation on the file system; and
creating the second metadata file based on the log.

5. The computer system according to claim 1, wherein
the search server is configured to execute:
converting the search request into a single-file search request for one or more single metadata files in the file storage; and
transmitting the single-file search request as the file storage search request to a file storage having a corresponding metadata file, and
the file storage is configured to execute:
receiving the single-file search request; and
searching for a file from a corresponding metadata file according to the single-file search request.

6. A file storage that manages a file system, the file storage comprising:
a storage device; and
a processor, wherein
the storage device stores a first metadata file that stores metadata regarding a file in a snapshot of a file system managed by the file storage, and
the processor is configured to execute:
receiving a file storage search request from a search server;
searching for a file from the first metadata file based on the file storage search request; and
returning a search result obtained by the searching to the search server.

7. A computer system comprising:
a search server; and
a plurality of file storages that manage a file system, wherein
the file storage is configured to execute:
sequentially transmitting metadata related to a file operated in a file system managed by the file storage to the search server, and
the search server is configured to execute:
receiving the metadata from the file storage to reflect the metadata in a metadata database;
receiving a search request for a file to be searched;
searching for a file corresponding to the search request by using the metadata database; and
returning a search result obtained by the searching to a request source of the search request.
